(19) United States
(12) Patent Application Publication
(10) Pub. No.: US 2025/0135585 A1
(43) Pub. Date: May 1, 2025

(54) LASER PROCESSING DEVICE AND METHOD

(71) Applicant: INDUSTRIAL TECHNOLOGY RESEARCH INSTITUTE, HSINCHU (TW)

(72) Inventors: Pin-Hao HU, Tainan City (TW); Chien-Jung HUANG, Tainan City (TW); Yu-Chung LIN, Tainan City (TW)

(21) Appl. No.: 18/773,533

(22) Filed: Jul. 15, 2024

(30) Foreign Application Priority Data
Nov. 1, 2023 (TW) 112142100

(51) Int. Cl. B23K 26/53; B23K 26/046; B23K 26/064; B23K 26/073

(52) U.S. Cl. CPC B23K 26/53; B23K 26/046; B23K 26/064; B23K 26/0734

(57) ABSTRACT

A laser processing device includes a laser beam source, a compensation system, and an imaging system. The laser beam source is configured to provide a laser beam, in which a non-zero angle is defined between an optical axis of the laser beam and a normal direction of the surface of the workpiece. The compensation system includes a phase compensation sheet. The phase compensation sheet is configured to force the laser beam spreading away from the optical axis thereby forming a beam pattern, and the phase compensation sheet is designed based on the non-zero angle. The imaging system is configured to transform the beam pattern to a processing beam that focuses on a processing position, and a distance from the phase compensation sheet to the laser beam source along the optical axis is decided according to a processing depth of the processing position. A laser processing method is also disclosed.

### CROSS-REFERENCE TO RELATED APPLICATION

This application claims priority to Taiwan Application Serial Number 112142100, filed Nov. 1, 2023, which is herein incorporated by reference in its entirety.

### BACKGROUND

### Field of Invention

The present disclosure relates to a laser processing device and a laser processing method.

### Description of Related Art

Laser drilling technique has been widely utilized in many industries. In order to achieve the purposes of high-capacity signal transmission requirement in the fields such as thinner and lighter 3C devices, high-frequency communications, and 4K image, through glass via (TGV) technique is utilized in the related art. There is a need to provide laser processing device and method to drill holes efficiently.

### SUMMARY

According to some embodiments of the disclosure, a laser processing device configured to process on a workpiece is provided. The laser processing device includes a laser beam source configured to provide a laser beam, wherein a non-zero angle is defined between an optical axis of the laser beam and a normal direction of a surface of the workpiece. The laser processing device includes a compensation system and an imaging system. The compensation system includes a phase compensation sheet configured to force the laser beam spreading away from the optical axis to form a beam pattern, wherein the phase compensation sheet is designed based on the non-zero angle. The imaging system includes a first optical component configured to primary focus the beam pattern, and a second optical component configured to secondary focus the primary focused beam pattern to transform the beam pattern into a processing beam focusing on a processing position. An air gap along the optical axis between the first optical component and the second optical component substantially equals to a sum of a first focus of the first optical component and a second focus of the second optical component. A distance from the phase compensation sheet to the laser beam source along the optical axis is decided according to a processing depth of the processing position.

According to some embodiments of the disclosure, a laser processing method for inclined processing a workpiece is provided. The laser processing method includes providing a laser beam by using a laser beam source, wherein a non-zero angle is defined between an optical axis of the laser beam and a normal direction of a surface of the workpiece; using a compensation system to force the laser beam spreading away from the optical axis to form a compensated beam pattern; entering the compensated beam pattern in an imaging system, wherein the compensated beam pattern is primary focused by a first optical component of the imaging system; secondary focusing the primary focused beam pattern by a second optical component of the imaging system to transform the beam pattern into a processing beam focusing on a processing depth of the workpiece, wherein an air gap along the optical axis between the first optical component and the second optical component substantially equals to a sum of a first focus of the first optical component and a second focus of the second optical component; and adjusting a distance from a phase compensation sheet of the compensation system to the laser beam source along the optical axis corresponding to a changing of the processing depth.

It is to be understood that both the foregoing general description and the following detailed description are by examples, and are intended to provide further explanation of the disclosure as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a laser processing device according to some embodiments of the disclosure.

FIG. 2 is a schematic view of a laser processing device at another processing stage according to some embodiments of the disclosure.

FIG. 3A, FIG. 3B, and FIG. 3C are schematic views of different Bessel laser beams.

FIG. 4 is a flow chart of a method of designing the laser processing device according to some embodiments of the disclosure.

FIG. 5A is schematic view of operating laser processing using the laser processing device according to some embodiments of the disclosure.

FIG. 5B is a diagram showing a relationship between the shifting of the phase compensation sheet and time of the laser processing device according to some embodiments of the disclosure.

FIG. 6 is a schematic view of the laser processing device according some other embodiments of the disclosure.

FIGS. 7A, 7B, and 7C are schematic views of operating the laser processing device according to some embodiments of the disclosure.

FIG. 8A is a schematic view of operating the laser processing device to form the inclined taper hole according to some embodiments of the disclosure.

FIG. 8B is a diagram showing a relationship between the shifting of the phase compensation sheet and time of the laser processing device according to some embodiments of the disclosure.

FIG. 9 is a flow chart of a laser processing method according to some embodiments of the disclosure.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts.

The TSV technique includes using a laser beam drilling on a glass substrate. For example, in the optical communication field, the glass drilling utilized in the connector thereof is an inclined surface laser drilling, to reduce the optical signal loss during the transmission. However, such inclined surface laser drilling technique faces a problem that the optical axis of the laser beam cannot enter the processing object vertically, so that the laser beam is deformed and the energy distribution of the laser beam becomes uneven. Additionally, the current laser workpiece is limited by the laser diffraction characteristic, and the efficiency of taper hole drilling is also limited. Thus the requirement of local adjusting from a straight hole to a taper hole in a single laser drilling process cannot be satisfied.

The present disclosure provides a laser processing device and a laser processing method. By using the compensation system to compensate the phase difference of the inclined laser processing process, the problem of processing beam pattern distortion can be prevented. The shifting of the phase compensation sheet of the compensation system is linear to the processing depth of the processing beam and is not related to the position of the workpiece, thus the purposes such as simplifying controlling mechanism, reducing process error, improving processing quality, increasing fabricating speed, etc. can be achieved.

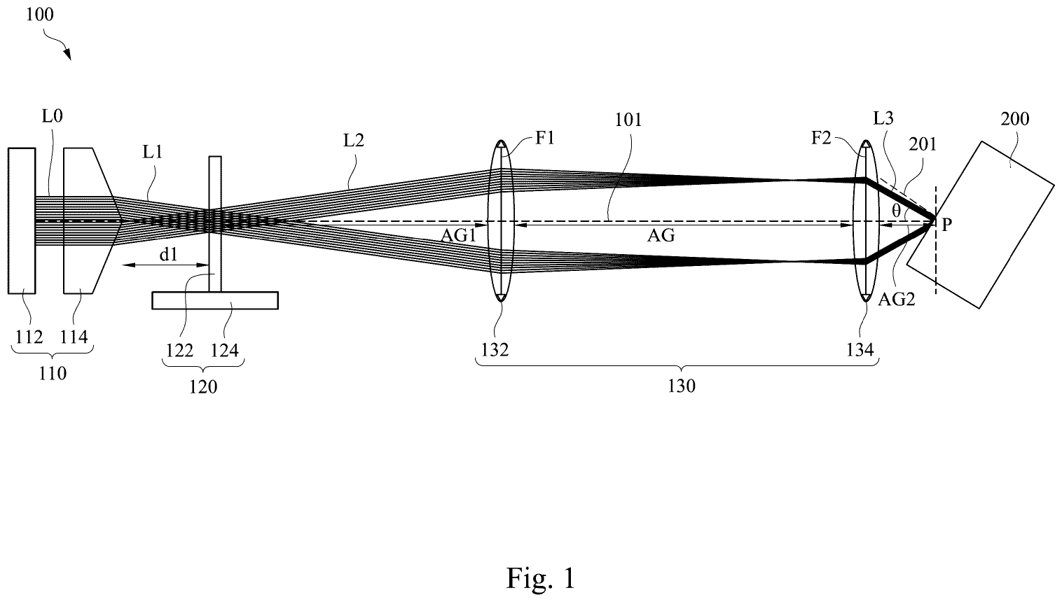

Reference is made to FIG. 1, which is a schematic view of a laser processing device according to some embodiments of the disclosure. A laser processing device 100 is configured to process a workpiece 200 such as performing an incline processing, to laser drilling the workpiece 200 such as a glass substrate. When the laser processing device 100 inclined processes the workpiece 200, an angle θ is defined between an optical axis 101 of a processing beam L3 provided by the laser processing device 100 and a normal direction 201 of the surface of the workpiece 200, and the angle θ is a non-zero angle. In some embodiments, the non-zero angle θ is less than 30 degrees. The light field vibration of transmittance of the processing beam L3 in this range is small, so that the phase compensation function can be achieved by using the laser processing device 100 of the disclosure, in which the laser processing device 100 includes compensation system 120 with designed phase compensation sheet 122.

The laser processing device 100 includes a laser beam source 110, a compensation system 120, and an imaging system 130. The laser beam source 110 is configured to generate a laser beam L1, in which the laser beam L1 is a laser having phase difference. Therefore, if the optical axis 101 of the laser beam L1 (e.g. the optical axis 101 of processing beam L3) is unable to enter the surface of the workpiece 200 vertically, the processing beam L3 would be deformed due to the non-zero angle θ between the optical axis 101 and the normal direction 201 of the workpiece 200.

The compensation system 120 is configured to phase compensate the laser beam L1 based on the inclined processing angle θ of the laser processing device 100 to the workpiece 200 which also referred as the non-zero angle θ between the optical axis 101 of the laser beam L1 (e.g. the optical axis 101 of processing beam L3) and the normal direction 201 of the workpiece 200. Therefore, the laser beam L1 is transformed to a beam pattern L2 that is phase compensated by the compensation system 120.

Then the phase compensated beam pattern L2 is further focused by the imaging system 130, to form the processing beam L3 on the processing position P of the workpiece 200. The processing beam L3 is compensated by the compensation system 120 corresponding to the inclined processing angle θ, thus the pattern of the processing beam L3 of the processing position P of the workpiece 200 is a scaling ratio of the pattern of the laser beam L1 provided by the laser beam source 110. The problem of pattern distortion between the laser beam L1 and the processing beam L3 due to inclined processing can be prevented.

Detail descriptions of the laser beam source 110, the compensation system 120, and the imaging system 130 of the laser processing device 100 are discussed in following.

The laser beam source 110 includes a laser generator 112 and an axicon 114. The laser generator 112 is configured to generate an emitting light L0. After the emitting light L0 passes the axicon 114, the emitting light L0 is modified by the axicon 114 to become the laser beam L1 with a ring shape. The axicon 114 can be a refractive type or a diffractive type. In some embodiments, the modified laser beam L1 can be a Bessel laser beam. The workpiece 200 is placed such that the non-zero angle θ is defined between the optical axis 101 of the laser beam L1 and the normal direction 201 of the workpiece 200.

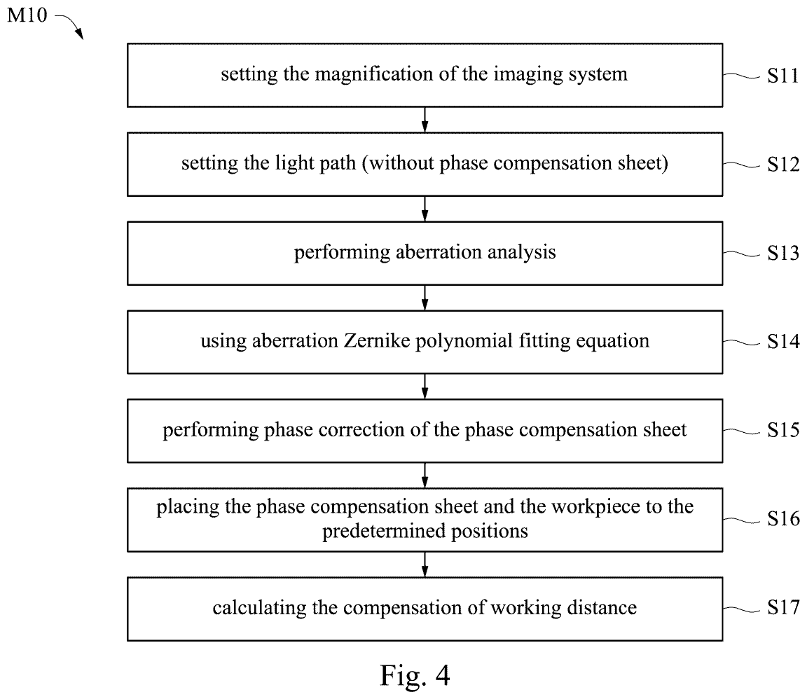

The compensation system 120 includes a phase compensation sheet 122. The phase compensation sheet 122 is configured to force the laser beam L1 spreading away from the optical axis 101 of the laser beam L1 to form the beam pattern L2. The phase compensation sheet 122 is designed based on the non-zero angle θ, so that the compensated beam pattern L2 is distorted from the laser beam L1. For example, a phase distribution of the laser beam L1 is symmetrical and a phase distribution of the compensated beam pattern L2 is asymmetrical, and/or the compensated beam pattern L2 is a deformed pattern of the laser beam L1, etc. The details of designing the phase compensation sheet 122 based on the non-zero angle θ are discussed in FIG. 4.

The imaging system 130 includes a first optical component 132 and a second optical component 134. The first optical component 132 is configured to primary focus the beam pattern L2 compensated by the compensation system 120. The second optical component 134 is configured to secondary focus the primary focused beam pattern L2 to transform the beam pattern L2 to the processing beam L3 that focuses on the processing position P. Because the beam pattern L2 has been phase compensated, and the phase compensation is designed based on the incline processing angle θ, therefore the processing beam L3 on the processing position P of the workpiece 200 is substantially a scaling ratio of the laser beam L1 provided by the laser beam source 110. The problem of the deformation of the processing beam L3 in inclined processing can be solved.

In some embodiments, the imaging system 130 is configured to provide a Kepler afocal image light path, in which an air gap AG between the first optical component 132 and the second optical component 134 on the optical axis 101 substantially equals to a sum of a first focus F1 of the first optical component 132 and a second focus F2 of the second optical component 134. The Kepler afocal image light path provided by the imaging system 130 has a benefit of a single magnification M_{ag}=F2/F1. That means the magnification M_{ag} is a constant value which is only related to the first focus F1 and the second focus F2 and is not related to the phase compensation sheet 122 or the processing position P. Therefore the imaging system 130 has advantages of maintain phase compensation sheet 122 phase constant and conjugation planes linearization.

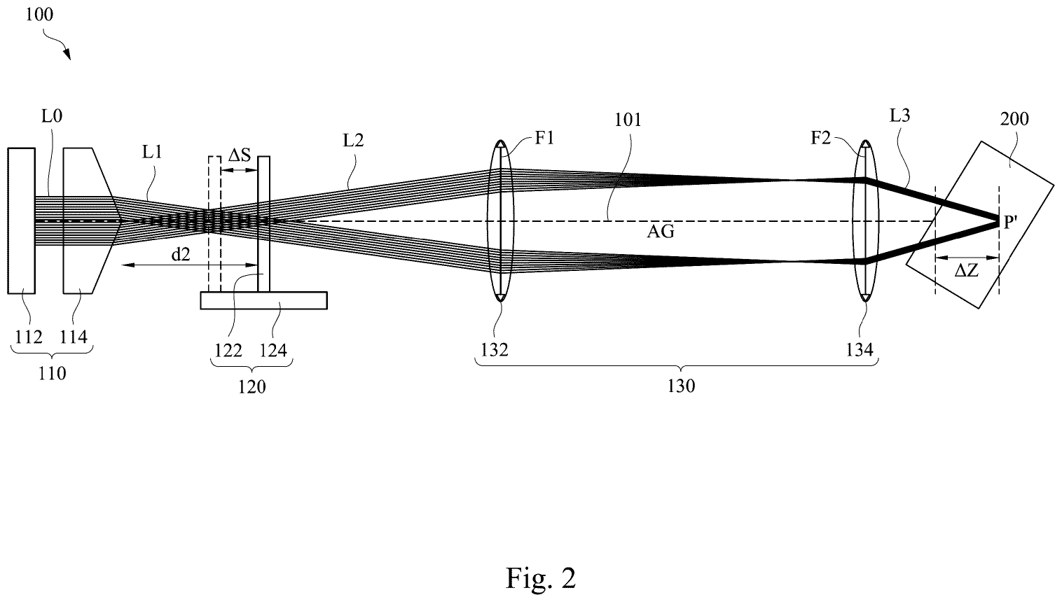

Please refer to both FIG. 1 and FIG. 2. FIG. 2 is a schematic view of a laser processing device at another processing stage according to some embodiments of the disclosure. While performing the laser processing process such as the laser drilling, the processing position P of the processing beam L3 on the workpiece 200 may be changed according to the requirement such as gradually deepen into the processing position P′ of the workpiece 200. Therefore, the compensation system 120 further includes an adjusting component 124 coupled to the phase compensation sheet 122. The adjusting component 124 is configured to adjust the distance from the phase compensation sheet 122 to the laser beam source 110 along the optical axis 101.

For example, when the processing beam L3 focuses on the processing position P as shown in FIG. 1, the processing depth of the processing beam L3 is on the surface of the workpiece 200 and is determined as a processing depth of zero. When the processing depth is zero, a first air gap AG1 between the phase compensation sheet 122 and first optical component 132 substantially equals to the first focus F1 of the first optical component 132. In some embodiments, an error range between the first air gap AG1 between the phase compensation sheet 122 and first optical component 132 and the first focus F1 of the first optical component 132 is less than 15% when the processing depth is zero. When the processing depth is zero, a second air gap AG2 between the workpiece 200 and second optical component 134 substantially equals to the second focus F2 of the second optical component 134. In some embodiments, an error range between the second air gap AG2 between the workpiece 200 and second optical component 134 and the second focus F2 of the second optical component 134 is less than 15% when the processing depth is zero. The distance from the phase compensation sheet 122 to the laser beam source 110 along the optical axis 101 is the distance d1.

When the processing beam L3 focuses on the processing position P′ as shown in FIG. 2, the processing depth of the processing beam L3 is deeper into the workpiece 200, and the desired processing depth of the processing beam L3 is determined as a processing depth ΔZ. The phase compensation sheet 122 is moved towards the workpiece 200 with a shifting ΔS, so that the processing beam L3 can focus on the processing position P′ having the shifting ΔS. The distance from the phase compensation sheet 122 to the laser beam source 110 along the optical axis 101 is the distance d2. The shifting of the phase compensation sheet 122 is ΔS=ΔZ/M_{ag}², in which ΔZ is the processing depth, magnification M_{ag} is F2/F1, F1 is the first focus of the first optical component 132, and F2 is the second focus of the second optical component 134.

The magnification M_{ag} is a constant value, so that the processing depth ΔZ of the processing beam L3 and the shifting ΔS of the phase compensation sheet 122 are also in a linear relationship. The imaging system 130 further provides advantage of conjugation planes linearization. Therefore, the laser processing device 100 only needs to adjust the shifting ΔS of the phase compensation sheet 122 from the laser beam source 110 along the optical axis 101 by the adjusting component 124 corresponding to the processing depth ΔZ of the processing beam L3, the processing beam L3 can successfully focus on the desired processing position such as the processing position P′ with the processing depth ΔZ. In some embodiments, the adjusting component 124 is a single axis moving mechanism. More particularly, the adjusting component 124 is configured to move the adjusting component 124 along the optical axis 101.

In some embodiments, an error range of the air gap AG between the first optical component 132 and the second optical component 134 on the optical axis 101 and the sum of the first focus F1 of the first optical component 132 and the second focus F2 of the second optical component 134 is within 15% of the sum of the first focus F1 of the first optical component 132 and the second focus F2 of the second optical component 134. If the aforementioned error range is greater than 15% of the sum of the first focus F1 of the first optical component 132 and the second focus F2 of the second optical component 134, the magnification of the Kepler afocal image light path of the imaging system 130 is no longer a constant value, such that the linearity between the processing depth ΔZ of the processing beam L3 and the shifting ΔS of the phase compensation sheet 122 is reduced. A complicate non-linear control system is required.

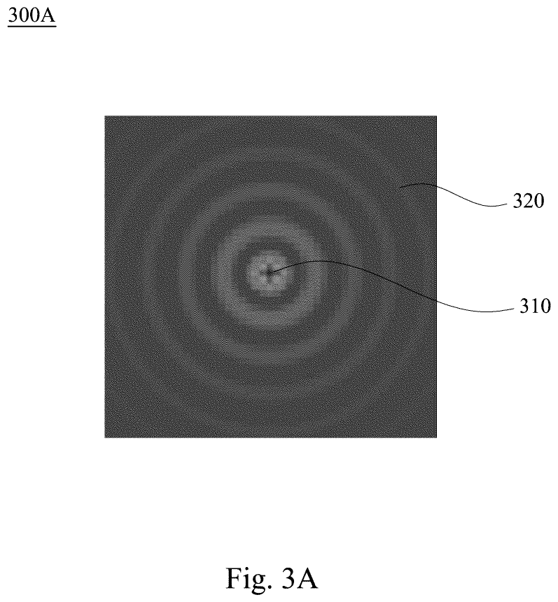

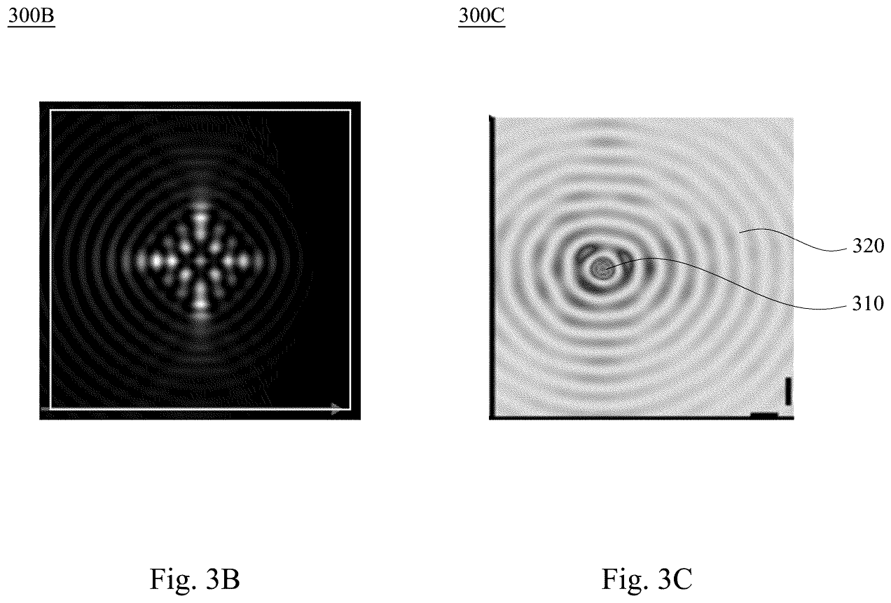

Reference is made to FIG. 3A, FIG. 3B, and FIG. 3C. FIG. 3A is an ideal Bessel laser beam 300A which includes a center spot 310 and a plurality of rings 320 coaxial to the center spot 310. The Bessel laser beam 300A may correspond to the form of the laser beam L1 provided by the laser beam source 110 in FIG. 1.

FIG. 3B is an uncompensated Bessel laser beam 300B focusing on the workpiece of an inclined processing process using a laser processing device without a compensation system according other embodiments. Obviously, the uncompensated Bessel laser beam 300B is distorted.

FIG. 3C is a compensated Bessel laser beam 3000 focusing on the workpiece of an inclined processing process using the laser processing device with the compensation system according some embodiments of the disclosure. The phase compensated Bessel laser beam 3000 still includes the center spot 310 and the rings 320 coaxial to the center spot 310. In some embodiments, the diameter of the center spot 310 is in a range from 1-20 μm.

Reference is made to both FIG. 1 and FIG. 4. FIG. 4 is a flow chart of a method of designing the laser processing device according to some embodiments of the disclosure. The method of designing the laser processing device M10 begins at step S11 including setting the magnification M_{ag} of the imaging system 130, in which the magnification M_{ag} is a value of the second focus F2 of the second optical component 134 to the first focus F1 of the first optical component 132 (F2/F1). The step S11 includes determining the first focus F1 of the first optical component 132 and the second focus F2 of the second optical component 134 thereby further determining the air gap AG between the first optical component 132 and second optical component 134. The gap AG between the first optical component 132 and second optical component 134 substantially equals to the sum of the first focus F1 of the first optical component 132 and the second focus F2 of the second optical component 134, and the error range thereof is within 15% of the sum of the first focus F1 of the first optical component 132 and the second focus F2 of the second optical component 134.

Step S12 includes setting the light path such as setting the light path of the Bessel laser beam. Step S12 includes deciding the position of the laser generator 112 and the axicon 114 and further obtaining the positions of the conjugation planes in the light path. Step S12 is made without considering the phase compensation sheet. In step S12, the factors of the refractive index of the workpiece 200 such as the refractive index of the glass substrate and the inclined processing angle are not considered.

Step S13 includes performing a surface aberration analysis of the workpiece 200 such as the glass substrate. Then step S14 includes using aberration Zernike polynomial fitting equation to obtain coefficients thereof, in which the aberration Zernike polynomial fitting equation is a popular tool to analyze optical aberration. The aberration Zernike polynomial fitting equation can be used as a foundation function for aberration fitting. Any aberration can be performed by orders (m, n) and coefficients of the Zernike polynomial equation. The Zernike polynomial equation includes odd and even, in which the even Zernike polynomial is defined as Zₙ^{m}(ρ, φ)=Rₙ^{m}(ρ) cos(m φ), and the odd Zernike polynomial is defined as Zₙ^{-m}(ρ, φ)=Rₙ^{m}(ρ) sin(m φ), in which the n and m are integrates, and n≥m≥0. The radial polynomial R(m, n) is defined as

$${R}_{n}^{m} ( ρ ) = {\sum }_{k = 0}^{\frac{n - m}{2}} \frac{{( - 1 )}^{k} ( n - k ) !}{k ! ( \frac{n + m}{2} - k ) ! ( \frac{n - m}{2} - k ) !} {ρ}^{n - 2 k} ,$$

in which ρ is the radial distance, and 0≤ρ≤1.

Please note that the factor of the inclined processing angle is considered in the performing the surface aberration analysis of the workpiece 200 of step S13 and the using aberration Zernike polynomial fitting equation of step S14. An aberration ϕ_{aberration}(X,Y) of the surface of the workpiece 200 can be obtained after the step S13 and step S14 are performed.

Step S15 includes performing a phase correction of the phase compensation sheet 122. Because the imaging system 130 is an afocal imaging system which has a single magnification M_{ag}. That is, the magnification M_{ag} is not related to the phase compensation sheet 122 or the processing position P. The imaging system 130 has advantages of maintain phase compensation sheet 122 phase constant and conjugation planes linearization, so that the corresponding phase correction of the phase compensation sheet 122 can be defined as ϕ_{correction}(X,Y)=ϕ_{aberration}(M_{ag}*X,M_{ag}*Y), which is linear to the aberration ϕ_{aberration}(X,Y) of the surface of the workpiece 200.

Step S16 includes placing the phase compensation sheet 122 and the workpiece 200 to the predetermined positions. As mentioned above, the predetermined position of the phase compensation sheet 122 is between the laser beam source 110 and the first optical component 132, and the first air gap AG1 between the phase compensation sheet 122 and the first optical component 132 substantially equals to the first focus F1 of the first optical component 132. The predetermined position of the workpiece 200 is at the position that the second air gap AG2 between the workpiece 200 and the second optical component 134 substantially equals to the second focus F2 of the second optical component 134.

Finally, step S17 includes calculating of the compensation of the working distance of the phase compensation sheet 122. The shifting of the phase compensation sheet 122 is ΔS=ΔZ/M_{ag}², in which ΔZ is the processing depth, magnification M_{ag} is F2/F1, F1 is the first focus of the first optical component 132, and F2 is the second focus of the second optical component 134. The shifting ΔS of the phase compensation sheet 122 and the processing depth ΔZ of the processing beam L3 are in the linear relationship.

Accordingly, the laser processing device 100 has advantages of constant magnification and conjugation planes linearization of the afocal imaging system and the advantage of the shifting ΔS of the phase compensation sheet 122 and the processing depth ΔZ of the processing beam L3 are in the linear relationship. Therefore, the design and operation of the laser processing device 100 can be simplified as the linear relationship and can quickly response during the laser processing manufacturing.

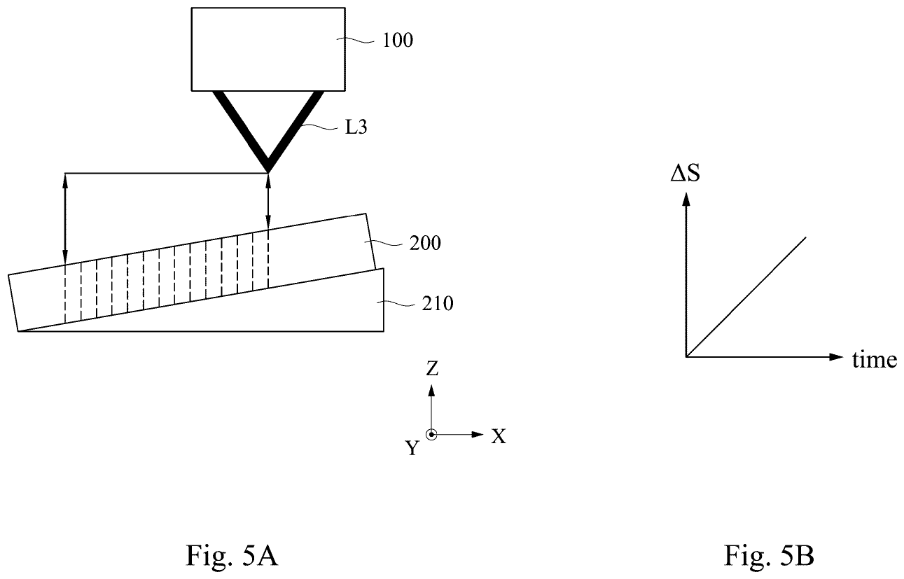

Reference is made to FIG. 5A and FIG. 5B. FIG. 5A is schematic view of operating laser processing using the laser processing device according to some embodiments of the disclosure. FIG. 5B is a diagram showing a relationship between the shifting ΔS of the phase compensation sheet 122 and time of the laser processing device according to some embodiments of the disclosure. In some embodiments, the workpiece 200 is a glass substrate, and the workpiece 200 is fixed on a holder 210. The holder 210 and the workpiece 200 thereon are positioned inclined relative to the laser processing device 100 such that the processing beam L3 inclined processes the workpiece 200.

For example, the processing beam L3 inclined processing the workpiece 200 is a through-glass via (TGV) array processing. When the laser processing device 100 is moved relative to the holder 210, here takes the holder 210 static and moving the laser processing device 100 for example, an array of inclined holes having constant inner diameter can be formed on the workpiece 200 by controlling the processing depth of the processing beam L3 provided by the laser processing device 100.

More particularly, the holder 210 can be an X-Y plane holder, and the height of the holder 210 measured in the Z direction is gradually increased or decreased along the X direction. Therefore, the laser processing device 100 only moves relative to the holder 210 in the X direction or the Y direction while using the laser processing device 100 to form the inclined holes array. The processing depth of the processing beam L3 in the Z direction can be controlled by adjusting the shifting ΔS of the phase compensation sheet 122 along the optical axis 101, as shown in FIG. 1 and FIG. 2.

As shown in FIG. 5B, the shifting ΔS of the phase compensation sheet 122 is linear to the processing depth ΔZ and is not related to the position of the workpiece 200, so that the shifting ΔS of the phase compensation sheet 122 and time are also in a linear relationship. Thus the purposes such as simplifying controlling mechanism, reducing process error, improving processing quality, increasing fabricating speed, etc. can be achieved.

However, in the laser inclined processing field, there is not only a demand of drilling inclined holes having constant inner diameter, a demand of drilling inclined taper holes is also required. Therefore, there is a need to provide a laser processing device that is able to drill inclined taper holes.

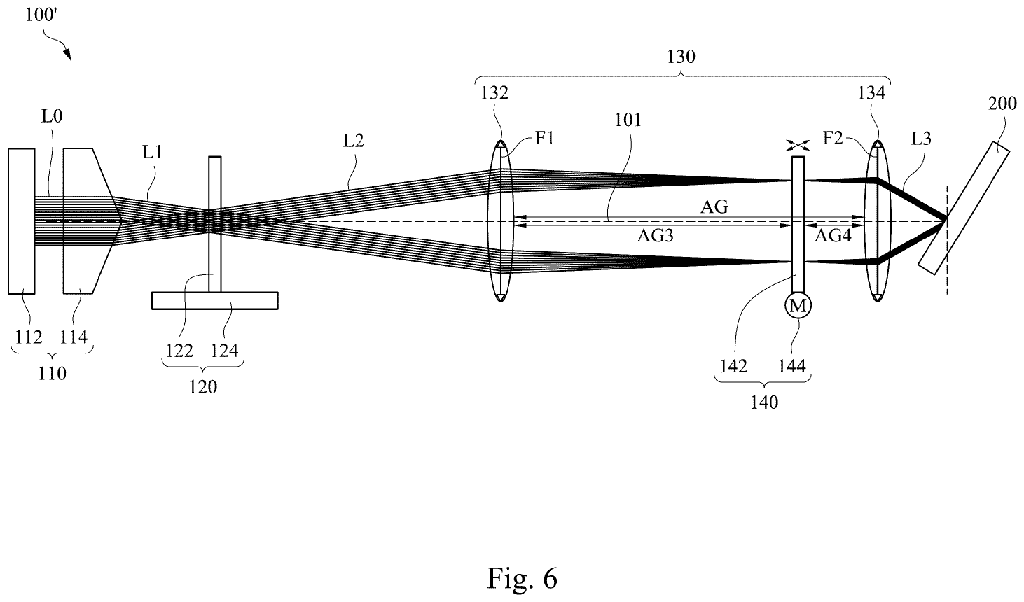

Reference is made to FIG. 6, which is a schematic view of the laser processing device according some other embodiments of the disclosure. The laser processing device 100′ includes the laser beam source 110, the compensation system 120, the imaging system 130, and further includes an offset component 140. The offset component 140 is disposed between the first optical component 132 and the second optical component 134. The offset component 140 is configured to offset the primary focused beam pattern L2 relative to the optical axis 101. More particularly, if the direction of the optical axis 101 is the Z direction, the offset component 140 is configured to offset the beam pattern L2 relative to the optical axis 101 on the X-Y plane.

In some embodiments, the air gap AG between the first optical component 132 and the second optical component 134 substantially equals to the sum of the first focus F1 of the first optical component 132 and the second focus F2 of the second optical component 134. A third air gap AG3 between the offset component 140 and the first optical component 132 substantially equals to the first focus F1 of the first optical component 132, and a fourth air gap AG4 between the offset component 140 and the second optical component 134 is substantially equals to the second focus F2 of the second optical component 134. Therefore, the imaging system 130 still provides afocal light path.

In some embodiments, the offset component 140 includes a two-axis vibration mirror 142 and a vibration mirror motor 144 coupled to the two-axis vibration mirror 142. The vibration mirror motor 144 is configured to drive the two-axis vibration mirror 142 vibrating in two-axis.

In some embodiments, the laser processing device 100 (as shown in FIG. 1) and the laser processing device 100′ further includes a programmable controller (not shown in the drawings). The programmable controller is coupled to the adjusting component 124 of the compensation system 120 and to the vibration mirror motor 144 of the offset component 140 (if exists). Thus the shifting of the phase compensation sheet 122 and the vibration of the two-axis vibration mirror 142 can be set according to the laser processing path.

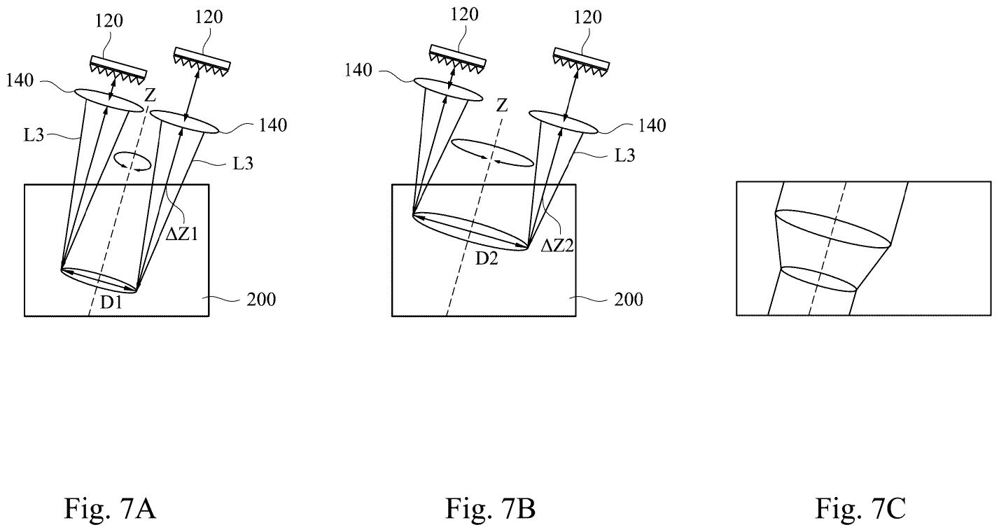

Reference is made to FIG. 7A and FIG. 7B, which are schematic views of operating the laser processing device according to some embodiments of the disclosure. Comparing to FIG. 7B, the processing position illustrated in FIG. 7A has a deeper processing depth ΔZ1 and a smaller processing diameter D1. Namely, the processing position illustrated in FIG. 7B has a shallower processing depth ΔZ2 and a larger processing diameter D2. When performing the laser processing as shown in FIG. 7A or FIG. 7B, the offset component 140 shown in FIG. 6 can offset the processing beam L3 on the X-Y plane (regarding the processing depths ΔZ1, ΔZ2 as Z direction), thereby changing the processing diameter such as tuning from the smaller processing diameter D1 of FIG. 7A to the larger processing diameter D2 of FIG. 7B. The compensation system 120 shown in FIG. 6 can change the focal depth of the processing beam L3, thereby changing the processing diameter such as tuning from the deeper processing depth ΔZ1 of FIG. 7A to the shallower processing depth ΔZ2 of FIG. 7B.

By designing the shifting amount of the compensation system 120 and the offset amount and offset frequency of the offset component 140, the processing depth and processing pattern of processing beam L3 can be varied, thereby forming the inclined taper hole as illustrated in FIG. 7C.

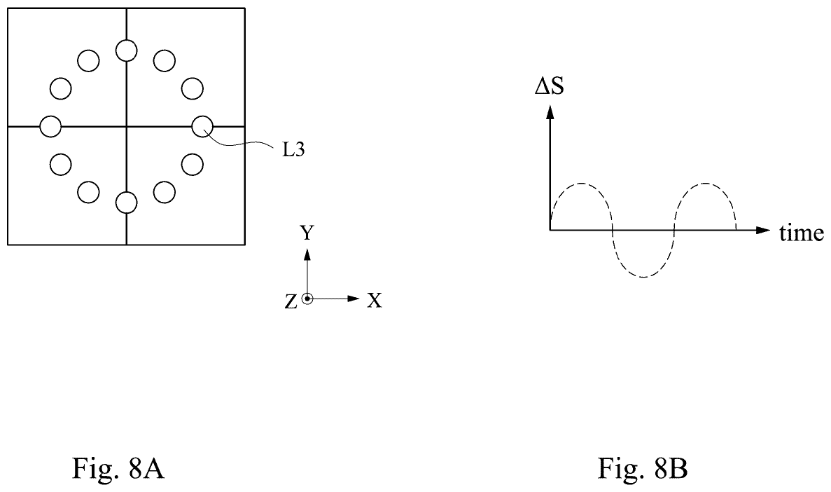

Reference is made to FIGS. 7A to 7C, FIG. 8A, and FIG. 8B. FIG. 8A is a schematic view of operating the laser processing device to form the inclined taper hole according to some embodiments of the disclosure. FIG. 8B is a diagram showing a relationship between the shifting ΔS of the phase compensation sheet 122 and time of the laser processing device according to some embodiments of the disclosure. In some embodiments, the position of the processing beam L3 such as the center spot of the Bessel laser beam can be distributed as a circle on the X-Y plane (regarding the processing depths ΔZ1, ΔZ2 as Z direction) by being offset by the offset component 140. The processing depth of the processing beam L3 in the Z direction is tuned by changing the shifting ΔS of the phase compensation sheet 122 on the optical axis.

As shown in FIG. 8B, the shifting ΔS of the phase compensation sheet 122 and time are in a simple harmonic relationship to reduce the error of tri-axial synchrony, because the path of the processing beam L3 is a circle and the shifting ΔS of the phase compensation sheet 122 and the processing depth of the processing beam L3 are in the linear relationship. Thus the purposes such as simplifying controlling mechanism, reducing process error, improving processing quality, increasing fabricating speed, etc. can be achieved.

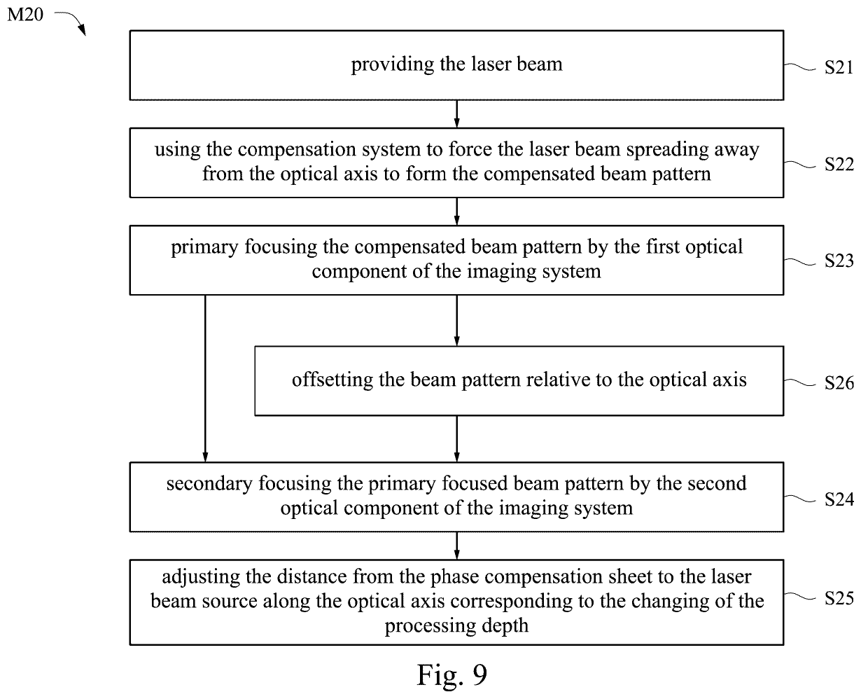

Reference is made to FIG. 9, which is a flow chart of a laser processing method according to some embodiments of the disclosure. Please note that the method of designing the laser processing device as shown in FIG. 4 should be completed, to set the components of the laser processing device based on the inclined processing angle, before performing the laser processing method M20.

The laser processing method M20 begins at step S21. The step S21 includes providing the laser beam, in which the laser beam is provided by the laser beam source. In some embodiments, the laser beam is a laser having phase difference such as a Bessel laser beam having a center spot and rings. The laser processing method M20 is utilized in inclined processing, in which a non-zero angle is defined between the optical axis of the laser beam and the normal direction of the surface of the workpiece.

Step S22 includes using the compensation system to force the laser beam spreading away from the optical axis to form the compensated beam pattern. The phase compensation sheet of the compensation system is designed based on the non-zero inclined processing angle, and the compensated beam pattern is formed by using the phase compensation sheet phase compensating the laser beam.

Step S23 includes entering the compensated beam pattern in the imaging system, and the compensated beam pattern is primary focused by the first optical component of the imaging system. Then step S24 includes secondary focusing the primary focused beam pattern by the second optical component of the imaging system to transform the beam pattern into the processing beam focusing on a processing depth of the workpiece. The air gap along the optical axis between the first optical component and the second optical component substantially equals to the sum of the first focus of the first optical component and the second focus of the second optical component, and the error range thereof is less than 15%.

The laser processing method M20 further includes step S25. Step S25 includes adjusting the distance from the phase compensation sheet to the laser beam source along the optical axis corresponding to the changing of the processing depth, in which the position of the phase compensation sheet is adjusted by operating the adjusting component of the compensation system. In some embodiments, the processing depth and the shifting of the phase compensation sheet are in a linear relationship, and the adjusting component is a single axis moving mechanism. In some embodiments, the predetermined position of the phase compensation sheet is that the first air gap between the phase compensation sheet and the first optical component substantially equals to the first focus of the first optical component, and the error range thereof is less than 15%. In some embodiments, the predetermined position of the workpiece is that the second air gap between the workpiece and the second optical component substantially equals to the second focus of the second optical component, and the error range thereof is less than 15%.

In some other embodiments, the laser processing method M20 optionally includes step S26. Step S26 includes offsetting the beam pattern relative to the optical axis. More particularly, the step S26 of offsetting the beam pattern relative to the optical axis includes offsetting the beam pattern that has been primary focused, so that the processing beam after being secondary focused is also offset relative to the optical axis. In some embodiments, the step S26 of offsetting the beam pattern relative to the optical axis includes using the offset component, and the position of the offset component is set that the third air gap between the offset component and the first optical component substantially equals to a first focus of the first optical component.

Step S21 to step S25 can be performed repeatedly and continuously to form the inclined holes having constant inner diameter. Step S21 to step S26 can be performed repeatedly and continuously to form the inclined taper holes having various inner diameters.

The compensation system compensates the phase difference of the inclined laser processing process to prevent the problem of processing beam pattern distortion. The shifting of the phase compensation sheet of the compensation system is linear to the processing depth of the processing beam and is not related to the position of the workpiece, thus the purposes such as simplifying controlling mechanism, reducing process error, improving processing quality, increasing fabricating speed, etc. can be achieved.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A laser processing device, configured to process on a workpiece, the laser processing device comprising:
a laser beam source configured to provide a laser beam, wherein a non-zero angle is defined between an optical axis of the laser beam and a normal direction of a surface of the workpiece; and
a compensation system comprising:
a phase compensation sheet configured to force the laser beam spreading away from the optical axis to form a beam pattern, wherein the phase compensation sheet is designed based on the non-zero angle; and
an imaging system comprising:
a first optical component configured to primary focus the beam pattern; and
a second optical component configured to secondary focus the primary focused beam pattern to transform the beam pattern into a processing beam focusing on a processing position, wherein an air gap along the optical axis between the first optical component and the second optical component substantially equals to a sum of a first focus of the first optical component and a second focus of the second optical component, wherein a distance from the phase compensation sheet to the laser beam source along the optical axis is decided according to a processing depth of the processing position.

2. The laser processing device of claim 1, wherein an error range between the air gap and the sum of the first focus of the first optical component and the second focus of the second optical component is within 15% of the sum of the first focus of the first optical component and the second focus of the second optical component.

3. The laser processing device of claim 1, wherein the non-zero angle is less than 30 degrees.

4. The laser processing device of claim 1, wherein the beam pattern comprises a center spot and a plurality of rings coaxial to the center spot.

5. The laser processing device of claim 1, wherein the laser beam source comprises a laser generator and an axicon, the laser generator is configured to generate an emitting light, and the axicon is configured to modify the emitting light to the laser beam with a ring shape.

6. The laser processing device of claim 5, wherein the beam pattern is distorted from the laser beam.

7. The laser processing device of claim 1, wherein when the processing position is on the surface of the workpiece, a first air gap between the phase compensation sheet and the first optical component substantially equals to the first focus of the first optical component, and a second air gap between the workpiece and the second optical component substantially equals to the second focus of the second optical component.

8. The laser processing device of claim 7, wherein an error range between the first air gap and the first focus is less than 15%, and an error range between the second air gap and the second focus is less than 15%.

9. The laser processing device of claim 1, further comprising an offset component disposed between the first optical component and the second optical component, wherein the offset component is configured to offset the primary focused beam pattern relative to the optical axis.

10. The laser processing device of claim 9, wherein a third air gap between the offset component and the first optical component substantially equals to the first focus of the first optical component.

11. The laser processing device of claim 9, wherein the offset component comprises a two-axis vibration mirror and a vibration mirror motor coupled to the two-axis vibration mirror.

12. The laser processing device of claim 1, wherein the compensation system comprises an adjusting component configured to adjust the distance from the phase compensation sheet to the laser beam source along the optical axis.

13. The laser processing device of claim 12, wherein the adjusting component is a single axis moving mechanism.

14. A laser processing method for inclined processing a workpiece, the laser processing method comprising:
providing a laser beam by using a laser beam source, wherein a non-zero angle is defined between an optical axis of the laser beam and a normal direction of a surface of the workpiece;
using a compensation system to force the laser beam spreading away from the optical axis to form a compensated beam pattern;
entering the compensated beam pattern in an imaging system, wherein the compensated beam pattern is primary focused by a first optical component of the imaging system;
secondary focusing the primary focused beam pattern by a second optical component of the imaging system to transform the beam pattern into a processing beam focusing on a processing depth of the workpiece, wherein an air gap along the optical axis between the first optical component and the second optical component substantially equals to a sum of a first focus of the first optical component and a second focus of the second optical component; and
adjusting a distance from a phase compensation sheet of the compensation system to the laser beam source along the optical axis corresponding to a changing of the processing depth.

15. The laser processing method of claim 14, further comprising designing the phase compensation sheet based on the non-zero angle.

16. The laser processing method of claim 14, wherein adjusting the distance from the phase compensation sheet to the laser beam source comprises operating an adjusting component of the compensation system.

17. The laser processing method of claim 14, further comprising setting a predetermined position of the phase compensation sheet and the workpiece, wherein a first air gap between the phase compensation sheet and the first optical component substantially equals to a first focus of the first optical component, and a second air gap between the workpiece and the second optical component substantially equals to a second focus of the second optical component.

18. The laser processing method of claim 14, further comprising offsetting the primary focused beam pattern relative to the optical axis by using an offset component.

19. The laser processing method of claim 18, wherein a third air gap between the offset component and the first optical component substantially equals to a first focus of the first optical component.

20. The laser processing method of claim 14, wherein the laser beam is a laser having phase difference.
